(19) United States
(12) Patent Application Publication
(10) Pub. No.: US 2010/0111217 A1
(43) Pub. Date: May 6, 2010

(54) METHOD AND SYSTEM FOR REDUCING PHASE DIFFERENCE AND DOPPLER EFFECTS IN DETECTION AND COMMUNICATION SYSTEMS

(76) Inventor: Vicente D. Fuente, Madrid (ES)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/633,576

(22) Filed: Dec. 8, 2009

Related U.S. Application Data
(63) Continuation-in-part of application No. 10/334,426, filed on Dec. 30, 2002, now Pat. No. 6,679,191.

(30) Foreign Application Priority Data
Dec. 8, 2008 (ES) P200803687

(51) Int. Cl. H04L 27/10; H04B 15/00

(52) U.S. Cl. 375/284; 375/285

(57) ABSTRACT

Disclosed is a detection or communication system and method. The detection or communication method and system includes a code generator for generating a set of N complementary Golay sequences, the code generator encodes a baseband signal with the complementary Golay sequences wherein the complementary Golay sequences have an ideal autocorrelation and the sum of cross-correlations of every Golay complementary sequence set is zero thereby reducing phase difference and Doppler effects. The detection or communication system and method also includes a modulator for modulating each of the N sets of encoded complementary Golay sequences onto separate frequencies and a transducer for transmitting the modulated N sets of encoded complementary Golay sequences, the transducer receiving the transmitted signal reflected from an object, a demodulator for demodulating the received signal into N sets of complementary baseband signals and a correlator for correlating the demodulated complementary baseband signals, thereby generating a signal from the correlated baseband signals.

### CROSS REFERENCE TO RELATED APPLICATION

This application is a Continuation-in-Part of pending U.S. application Ser. No. 10/334,426, filed Feb. 12, 2003 and entitled “Method, Transmitter and Receiver for Spread-spectrum Digital Communication by Golay Complementary Sequence Modulation” and claims benefit to Spanish Patent Application No. P200803687, the disclosure of each of which is hereby expressly incorporated herein by reference.

### FIELD OF TECHNOLOGY

The present disclosure relates generally to detection and communication systems in which Doppler effects may be reduced.

### BACKGROUND

In current detection and communication devices, Doppler effects are prevalent during detection of an object. The Doppler effect is the change in frequency of a wave for a receiver relative to the source of the wave. That is, the received frequency at a receiver is higher compared to the emitted frequency when the object being detected is approaching the receiver, it is identical at the instant the object passes by, and it is lower during a recession.

In detection systems such as, for example, RADAR, SONAR and spectroscopic devices, a transmission signal propagates through a media, such as for example, air or water, and is absorbed and/or reflected by the object being detected. The signal may undergo a modification to its parameters such that the phase that is received by a receiver, as well as the frequency and amplitude of the signal are modified by the displacement of detected objects with respect to the receiver. The received signal is detected in the form of the original signal, displaced in phase and frequency with different amplitudes due to the effects of absorption and reflection on the object.

Current detection and communication systems must account for the Doppler effects when performing calculations on the detected object. This may require significant processing power and time that may be better utilized for other functions within the device or the surrounding equipment.

Moreover, resolution of an object at a distance is one of the most important aspects of such systems (e.g. RADAR, SONAR, spectroscopic devices, terrain mapping devices). The resolution of an object received by communication devices may be limited by not only the shape of the transmitted signal but also by the effects of phase distortion, Doppler effects and Clutter. Clutter is a term used for unwanted echoes in electronic systems, such as, for example, RADAR. Such echoes are typically returned from ground, sea, rain, animals/insects, chaff and atmospheric turbulences, and can cause serious performance issues with the communication and detection systems.

Digital pulse compression is one of the techniques employed to increase resolution in distance. Digital pulse compression allows the possibility of using binary streams whose autocorrelation is ideal (A maximum peak defined with low side lobes) to increase resolution. In one example, Barker's sequences have been the used because of its proven immunity to Doppler effects. However, due to its reduced length (less than or equal to 13 bits) its application is limited to environments of low noise or high Doppler, where other techniques cannot be used.

Compression of frequency using linear functions modulated in frequency (LFM) or “Chirps” and all its variants is the technique most currently used to increase the bandwidth of a signal in communication and detection devices because it has the advantage of optimizing energy in an employed frequency band getting an ideal autocorrelation function [U.S. Pat. No. 4,633,185; U.S. Pat. No. 4,309,703]. By contrast, its Doppler immunity is low and has relatively high side lobes in the vicinity of the target object whether a widowed process or complex filtering is done or not.

In communication systems one of the biggest problems is interference between users. Code Division Multiple Access or CDMA is based on the properties of low cross-correlation of different sequences used by different users. Since the cross-correlation is not fully null, interference may occur due to the simultaneous access of multiple users called Multi-Access Interference (MAI). MAI prevents increasing the number of users over a certain limit related to such interference. Obviously, the movement of the users within the cell causes distortion phase and frequency due to the Doppler effect or reduces the transmission speed. This is especially harmful in multipoint-to-point systems (satellite links, mobile communications, etc) where different distances and speeds among users make it difficult to synchronize and maintain a low interference among users. Similarly, when there is a link from user to base station there is a phase difference among different users that also causes an increase in interference.

Further, communications between vehicles traveling at high speeds (e.g. planes, trains, spacecraft, missiles, satellites) are extremely sensitive to interference because spectral efficiency or data rates may be quickly reduced at high speeds.

Still further, the effect of sharing the same band of frequencies between subscribers or services is especially harmful in the cable xDSL broadband access systems where the Far end Crosstalk or FEXT may occur. When a number of subscribers sharing the same cable increases, the speed of data which is able to convey to each subscriber to a given distance decreases. This effect can become significant and reduce coverage for a particular service by up to 50% for average at, for example, 12 Mbps speeds and reach 2500% in the case of 20 Mbps, reducing from 1 km to 200 m radio coverage.

In addition, one of the biggest problems of pulse compression detection systems such as, for example, RADAR and SONAR is the need to disable the stages of reception during the time a compressed signal is transmitted, known as “blind time”. If the reception stages are not disabled then the stages may become saturated. It may then not be possible to receive correctly, the reflected pulses that reach the receiver before the emitted signal is completely sent. This effect limits both the minimum measurable distance of a pulsed radar and maximum process gain that can be obtained by compressing the signal. To avoid this, one common solution is to add a different transducer at reception with enough directionality to prevent the saturation of receiving stages while transmitting.

### BRIEF DESCRIPTION OF THE DRAWINGS

FIG. 1 a block diagram of an example encoding and decoding system.

FIG. 2 illustrates an example block diagram of an encoder employing N codes and N simultaneous frequencies.

FIG. 3 is a flow diagram showing an exemplary method in which the encoder may be employed.

FIG. 4 illustrates an example block diagram of an decoder employing N codes and N simultaneous frequencies.

FIG. 5 is a flow diagram showing an exemplary method in which the decoder may be employed.

FIG. 6 is a block diagram illustrating blind time and an alternative to blind time.

### DETAILED DESCRIPTION

One aspect of the invention relates to a method and the apparatus for encoding and decoding that, being applied to any system requiring to transmit and receive a signal through a transmission medium. The coding technique allows eliminating the effects of phase differences between transmitter and receiver and reducing the Doppler effect due to, in one example, the speed differences between both transmitter and receiver and/or differences between clocks and oscillators. This method reduces such effects allowing also the design of detection systems (RADAR, SONAR, Spectroscopic, mine detection, Non-Destructive Testing, etc) with better spatial resolution and sensitivity and lower computation power.

Further, in multiple simultaneous communication systems requiring different data flows without mutual interference, independent of the phase of arrival or delay (e.g. the upstream path in mobile communications or multipoint to point applications, DSL applications, etc), in one aspect of this invention, this method and apparatus allows cancelling the multi-access interference (MAI) independently of the phase and Doppler distortion of the signal reaching the receiver.

Still further, this method and apparatus, in another aspect of the invention, may allow transmitting and receiving signals simultaneously in detection systems, the blind time between measurements in pulse compression based systems.

The present invention may be used in many fields due to the broad spectrum of applications of this technology. As an example, the present invention can be used in the field of Communications such as cellular networks. In another example, the present invention may be used with detection devices such as RADAR or SONAR. In yet another example, the present invention can also be used in medical diagnostic devices based on imaging like echography, magnetic resonance or Computerized Tomography, also in the non invasive physical and chemical magnitudes measurement and the spectral analysis, among others. Other fields of technology not mentioned may also employ this encoding technique.

In one example, the encoding technique described herein may allow for an efficient and simple information transmission (compression/encoding process). The encoding technique described herein may also reduce destructive effects due to phase differences between signals received, the Doppler effect and “Clutter” and eliminate the “blind time” in RADAR and SONAR systems.

Complementary sequences may be used in order to perform these encoding techniques. As set forth herein, the terms encoding and coding may be used interchangeably. In one example, as will be shown in greater detail below, the encoding technique may include the use of N sets of complementary sequences using up to N different orthogonal channels. Complementary sequences may include any set of sequences which the addition of their autocorrelations resulting in a Kronecker delta.

Orthogonality is understood, in one example, as the sum of cross-correlations of every complementary sequence set is zero. In particular, certain pairs (N=2) of orthogonal scripts are called Golay sequences. One property of the sequences employed is that they have a feature of ideal autocorrelation, i.e. corresponds to a perfect Kronecker delta without side lobes and a null mutual cross-correlation between families within a set of orthogonal sequences.

In one aspect of the invention, the system may consist of two different blocks:

a. The encoding system at a transmitter.

b. The decoding system at a receiver.

Although described as two separate blocks, one of ordinary skill in the art would understand that the system described may be integrated as one. That is, the may be designed as a single system such as, for example in an Application Specific Integrated Circuit, a Field Programmable Gate Array (FPGA), or the like.

Applying the property of orthogonal sets, using different sets of orthogonal sequence sets, detection systems (RADARs, SONARs, etc) may be correlated and therefore may not interfere with each other even though they may be in close proximity to each other or use the same frequencies for transmission.

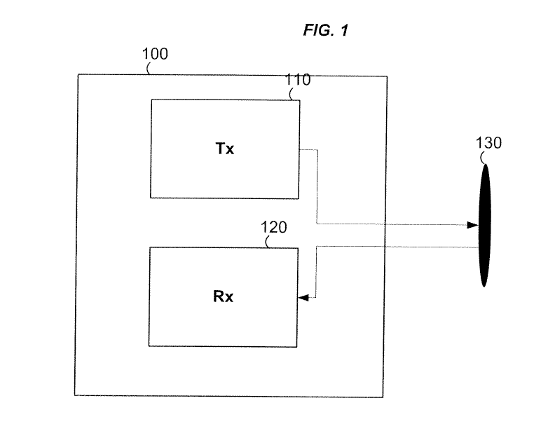

FIG. 1 is a block diagram of an example system 100 in which the present invention may be used. The system 100 includes a transmitter 110, a receiver 120, and a transducer 130. The transmitter 110 and receiver 120 may be described herein as an encoder 110 or a decoder 120 respectively. As noted above, although the transmitter 110 and receiver 120 are described herein separately, the transmitter 110 and receiver 120 may be employed as a single unit. The system 100 may be any of a number of communication or detection devices such as, for example, RADAR, SONAR, topography mapping devices, medical devices, etc. The transducer 130 may be any type of device that can transmit and receive signals such as for example an antenna. Although only one transducer is shown multiple transducers may also be used. For example, the transmitter 110 and receiver 120 may each have a separate transducer.

The encoder 110 may be responsible for generating and transmitting a set of complementary sequences at certain time intervals. The decoder 120, on the other hand may be responsible for the correlation of the received signals with the same set of complementary sequences used during encoding and add the results in order to recover the original information.

The encoding sequences employed in one example of this invention may have a characteristic of ideal autocorrelation, that is to say, a perfect Krönecker delta without side lobes and a null mutual cross-correlation between families within a set of orthogonal sequences, that meet:

$${φ}_{11} [ n ] + {φ}_{22} [ n ] + … + {φ}_{MM} [ n ] = {\sum }_{i = 1}^{M} {φ}_{ii} [ n ] = \{ \begin{matrix}MN , & n = 0 \\ 0 , & n \neq 0\end{matrix} \\ {\sum }_{i = 1}^{M} {Φ}_{ii} ( ω ) = cte , ∀ ω / {Φ}_{ii} ( ω ) = {Ω}_{i} ( ω ) {Ω}_{i}^{*} ( ω ) \\ {\sum }_{i =}^{M} {A}_{i} ( ω ) {B}_{i}^{*} ( ω ) = 0 , ∀ ω / A \neq B$$

Where Φᵢᵢ is the individual autocorrelations of each of the N complementary sequences of length M selected, and Φ and Ωᵢ is the frequency response (FFT) of the autocorrelation and the complementary sequence (i) of the family Ω inside the set of orthogonal sequences of length N in the bandwidth used and * the conjugate operator.

The generation of such sequences may be done from a kernel Basic known to date of 2, 10 and 26 bits (the rules of generation of families of complementary sequences are discussed in the article entitled “Complementary Sets of sequences” of C-C. Tsend and C. l. Liu, published in IEEE Trans. Inform. Theory, vol. IT-18, no. 5, pp. 644-651, September (1972) which is incorporated herein.

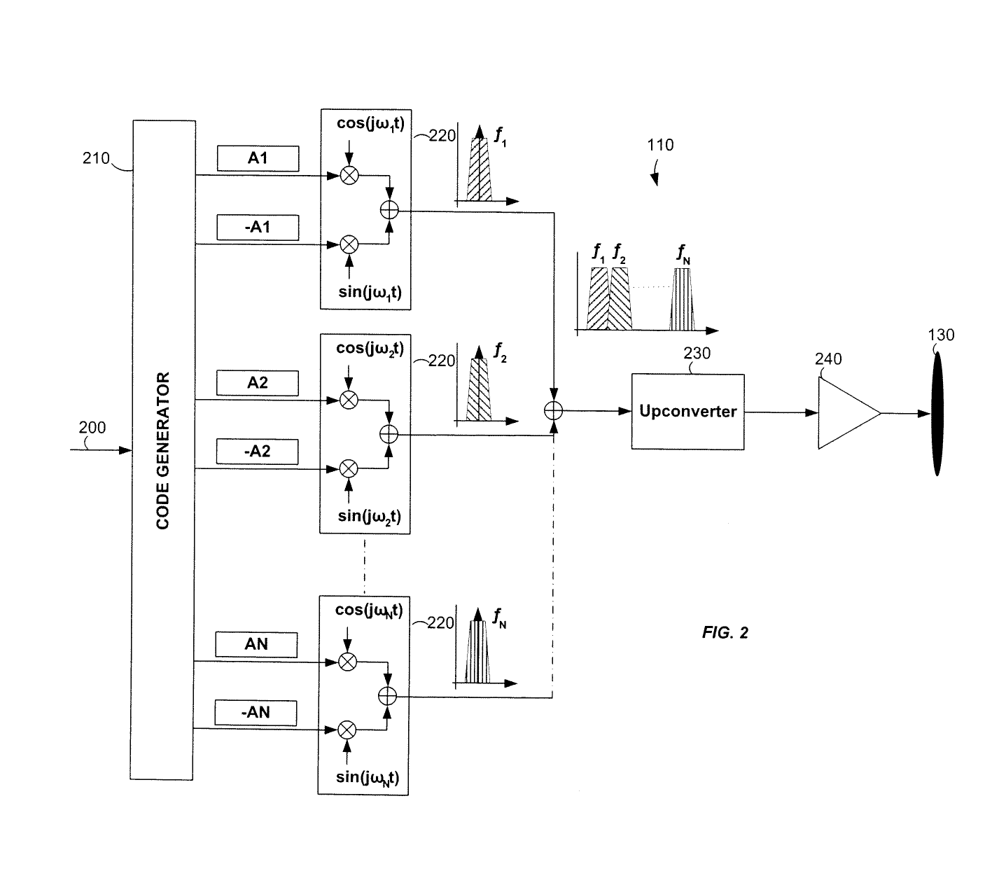

FIG. 2 illustrates an example block diagram of an encoder 110 employing N codes and N simultaneous frequencies. The encoder 110 includes a control signal 200, a code generator 210, N modulator blocks 220, an adder 230, an upconverter 240, and an amplifier 250.

The coder generator 210 may be triggered by the control signal 200 to start the encoding process. The control signal may include the originating signal. The control signal 200 may be sent from another part of the system or from an external device to begin the encoding process. For example, in a RADAR system, when a user may trigger the start of detecting nearby object the control signal 200 may begin the encoding process. The output of the code generator may, in one example, correspond to the convolution of the control signal with each of the generated sequences from the code generator 210. The generated sequences may be Golay complementary sequences which, as described above and in the co-pending application, have an ideal autocorrelation. In one example, for each frequency, at least one sequence may be sent in phase (A1) (A2), . . . (AN) and the same code changed in sign is sent in quadrature (−A1), (−A2), . . . (−AN) corresponding to the convolution of the control signal with each of the above sequences changed in sign.

Each of the signals from the code generator 210 may be modulated by the N modulator block 220 using N intermediate frequencies, f₁ to f_{N}. The modulator block 220 may be any of a variety of modulation techniques such as, for example, quadrature modulation. In on example, the modulator blocks 220 may employ QPSK, or QAM modulation. In another example the modulator blocks may employ M-PSK modulation. Each of the modulator blocks 220 may be identical, however, with a change in frequency at the output as shown in FIG. 2.

The modulated signals may then be added at adder 230. The added signals, or in one example, stacked signals, may upconverted to the frequency of transmission using a frequency converter or “upconverter” 240 and amplified using an amplifier 250. The upconverting technique used may be any of a variety of techniques including for example, the use of one or more mixers. Likewise, amplifier 250 may be any of a number of amplifiers such as, for example an operational amplifier. The amplified signal may then be sent or transmitted to a medium by means of transducer 130. One of ordinary skill in the art would understand that each of the elements described above may be employed as separate devices manufactured for specific functions or may be programmed as one integrated circuit such as an ASIC or an FPGA. Also, the devices described above may be implemented using digital direct conversion techniques such as, for example, D/A and/or A/D converters.

In one example, the number of bands N may depend on the size of the set of complementary sequences used and the number of systems or services to orthogonalyze if necessary.

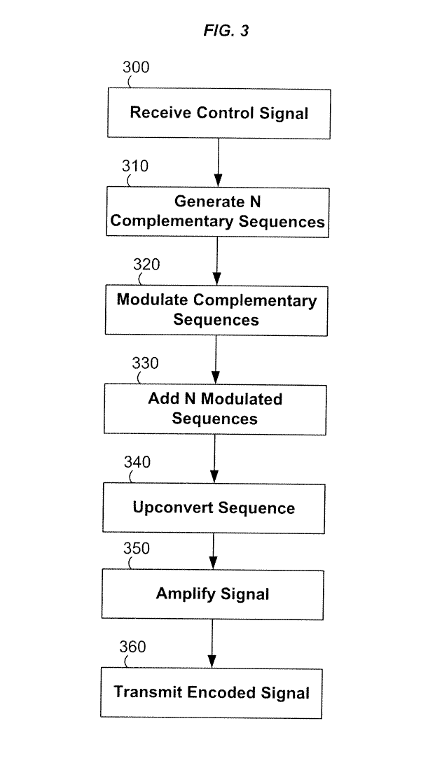

FIG. 3 is a flow diagram showing an exemplary method in which the encoder may be employed. At block 300 a control signal may be received triggering a code generator. At block 310 the code generator may generate N pairs of complementary sequences such as Golay sequences. At block 320 the N complementary sequences may each be modulated. Each pair of complementary sequences may be modulated via a modulator block to a different frequency. At block 330 the N sets of modulated sequences may be added or stacked to form, for example an intermediate frequency (IF). The added sequences may then be upconverted at block 340 to a transmission frequency. At block 350 the upconverted signal may be amplified and transmitted at block 360. The embodiments of each of the blocks in the method are described in the examples above.

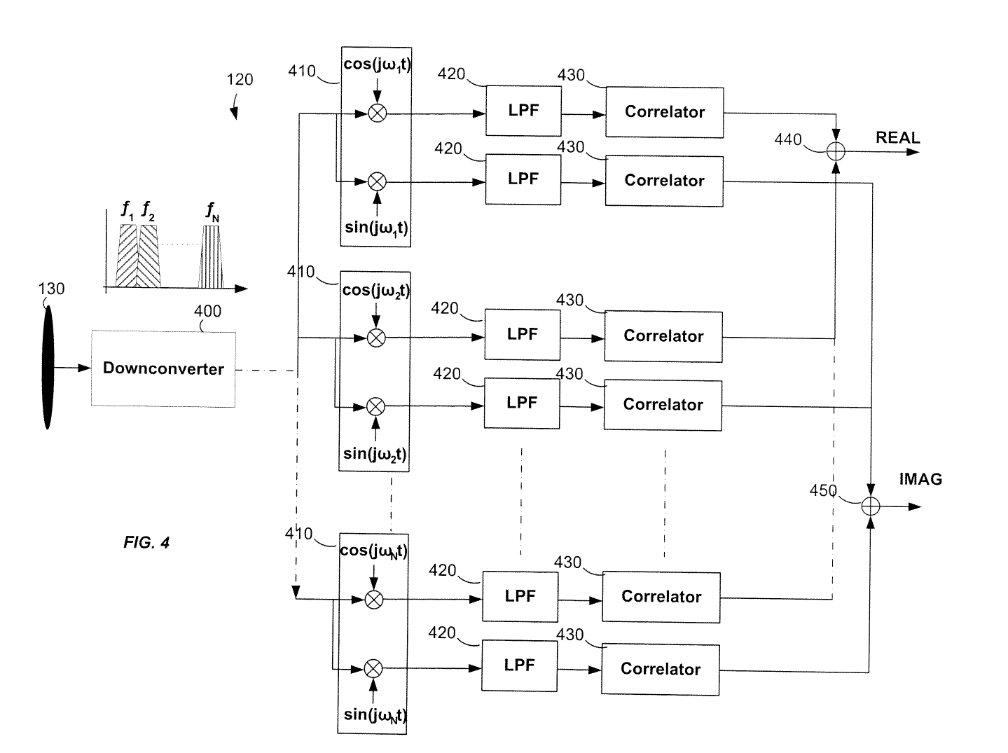

FIG. 4 is a block diagram of an example receiver/decoder 120. The decoder 120 corresponds to a detection or communication system shared by N users or devices, each device is assigned to a set of complementary orthogonal sequences to make them all independent and operate near each other without mutual interference. The decoder 120 includes a downconverter 400, N sets of demodulator blocks 410, N sets of filters 420, N sets of correlator blocks 430, and adders 440 and 450.

After the system receives a detection signal via transducer 130, such as a received signal reflected from a detected object for example, a downconverter 400 “downconverts” the received signal to an intermediate frequency. The downconverter 400 may be any of a variety of downconverters such as, for example, one or more mixers. Each of the flows transmitted using the N carrier frequencies are demodulated resulting in 2N signals in baseband using demodulator blocks 410. The output of each demodulator block 410 is filtered by a filter 420. The filter may be for example, a lowpass filter used to remove the out of band frequencies. These signals are correlated by the correlator block 430 by the corresponding replicas of the transmitted sequences which may be stored in the receiver. The adder 440 of the signals correlated in phase allows obtaining the information called real and the adder 450 of the signals correlated out of phase, in for example, quadrature allow obtaining the information called Imag. Thus, the received signal will be equivalent to the complex signal:

Rx=Real+j·Imag

A complex signal allows the system to obtain the information of phase and module of the signals received from transmitter, as well as information of displacement suffered by Doppler effect.

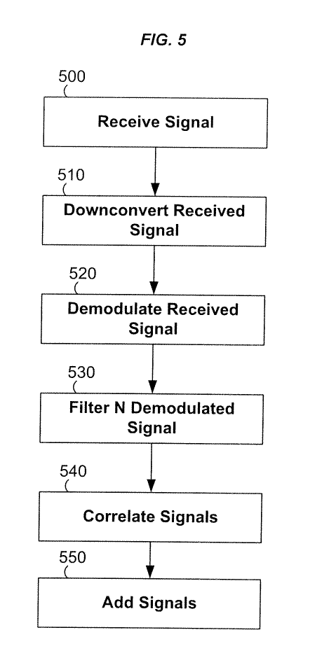

FIG. 5 is a flow diagram illustrating an example method of receiving and correlating a signal. At block 500 a signal is received at a transducer. The signal may be a reflected signal from an object being detected. At block 510 a downconverter downconverts the received signal to 2N sets of intermediate frequencies. Each of the sets of signals from the downconverter is then demodulated into separate frequencies using demodulators at block 520. At block 530 the demodulated signals are each sent through a filter to remove any unwanted frequencies. At block 530 the filtered signals are correlated by correlator blocks by the corresponding replicas of the transmitted sequences which may be stored in the receiver. At block 540 the adders add the in phase and out of phase signals resulting in information called real and imag respectively.

One of the biggest problems of detection systems based on pulse compression, such as RADAR and SONAR, is the need to disable the reception stages during the time the signal is transmitted, which is called “blind time”. If this is not done, these stages are saturated and unable to properly receive pulses reflected in objects arriving before the transmitted signal is completed sent. This effect both limits the minimum distance RADARs can measure and the maximum process gain that can be obtained by compressing the signal. To prevent this, a typical solution is to add a different transducer reception with sufficient directionality to prevent the saturation of receiving stages when transmitting.

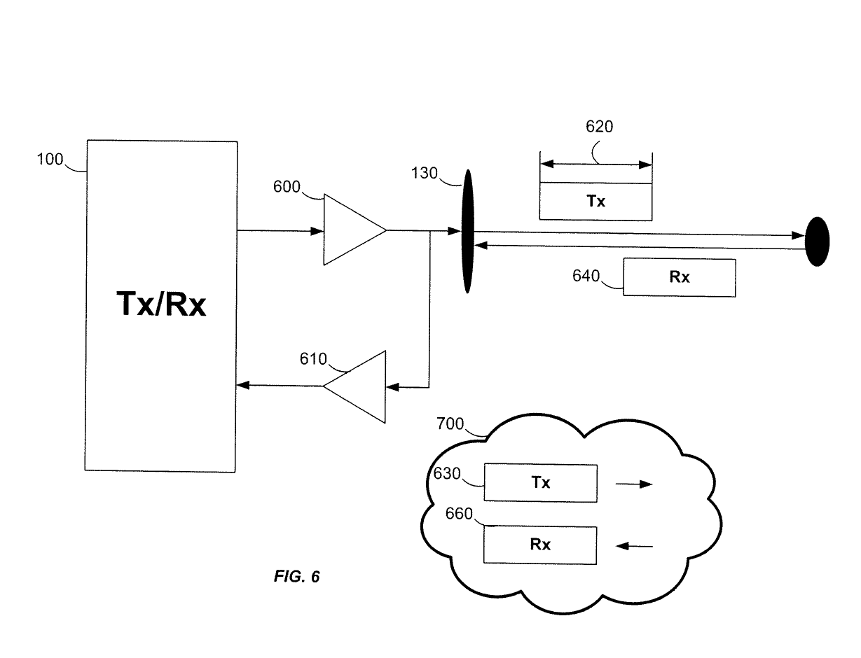

As illustrated in FIG. 6, a compressed signal transmission stage 600 and a reception stage 610 is shown. A transducer 130 sends and receives a signal. The time interval during which the transmitted codes 620 is called “blind time.”

Using the method described above, since the orthogonalization is independent of the phase and the received signals, for any separation greater than or equal to ½ of an intervals or half a binary bit sequence, it is possible to transmit a signal 630 and receive the pulses reflected 640 on objects 650 at the same time 660 as shown in 700, using a single transducer or antenna.

One advantage provided by the method described, is that since orthogonalization is independent of the phase and module of the received signals, and is true for any value greater than or equal to ½ of an interval in separation time, it is possible to transmit and receive the signals at the same time, using a single transducer or antenna and therefore eliminate the “blind time” between measures.

Another advantages of this technique is: to remove the dependence on the Doppler effect and the phase difference of the signals detected, to help reduce “Clutter”, to be able to build independent or orthogonal channels in time for different users running on the same band of frequencies and to eliminate “blind time” in detection systems.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this disclosure, which would still fall within the scope of the claims.

What is claimed is:

1. A method for reducing phase difference and Doppler effects in a detection or communication system comprising:
generating a set of N complementary Golay sequences;
encoding a baseband signal with the complementary Golay sequences wherein the complementary Golay sequences have an ideal autocorrelation and the sum of cross-correlations of every Golay complementary sequence set is zero;
modulating each of the N sets of encoded complementary Golay sequences onto separate frequencies;
transmitting the modulated N sets of encoded complementary Golay sequences using a transducer;
receiving the transmitted signal reflected from an object ;
demodulating the received signal into N sets of complementary baseband signals;
correlating the demodulated complementary baseband signals; and
generating a signal from the correlated baseband signals.

2. The method of claim 1, wherein a trigger begins the step of generating a set of N complementary Golay sequences.

3. The method of claim 1, wherein the encoded complementary Golay sequences are modulated using a quadrature modulation.

4. The method of claim 3, wherein the quadrature modulation is a QPSK modulation technique.

5. The method of claim 1, wherein the modulated N sets of complementary Golay sequences are added generating an intermediate frequency.

6. The method of claim 2, wherein the intermediate frequency is upconverted and amplified before being transmitted.

7. The method of claim 6, wherein the transducer is an antenna.

8. The method of claim 6, wherein the received signal is downconverted to an intermediate frequency.

9. The method of claim 1, wherein the demodulated N sets complementary baseband signals are each filtered to remove out of band frequencies.

10. The method of claim 1 wherein the signal generated from the correlated baseband signal includes an in phase and an out of phase portion.

11. The method of claim 1 wherein the modulated complementary Golay sequence can be continuously transmitted while the transducer receives the reflected signal.

12. A detection or communication system comprising:
a code generator for generating a set of N complementary Golay sequences, the code generator encodes a baseband signal with the complementary Golay sequences wherein the complementary Golay sequences have an ideal autocorrelation and the sum of cross-correlations of every Golay complementary sequence set is zero thereby reducing phase difference and Doppler effects;
a modulator for modulating each of the N sets of encoded complementary Golay sequences onto separate frequencies;
a transducer for transmitting the modulated N sets of encoded complementary Golay sequences;
the transducer receiving the transmitted signal reflected from an object;
a demodulator for demodulating the received signal into N sets of complementary baseband signals; and
a correlator for correlating the demodulated complementary baseband signals, thereby generating a signal from the correlated baseband signals.

13. The detection or communication system of claim 12 further comprising:
a control signal to trigger the code generator to generate the N sets of complementary Golay sequences.

14. The detection or communication system of claim 12 wherein the modulator is a quadrature modulator.

15. The detection or communication system of claim 12 further comprising an adder to generate an intermediate frequency using the N sets of modulated Golay sequences.

16. The detection or communication system of claim 15 further comprising an upconverter and an amplifier for upconverting and amplifying the generated intermediate frequency.

17. The detection or communication system of claim 16 wherein, the upconverter is made up of one or more mixers.

18. The detection or communication system of claim 12 wherein the transducer is an antenna.

19. The detection or communication system of claim 12 wherein the signal generated from the correlated baseband signals includes an in phase and out of phase portion.

20. The detection or communication system of claim 16 wherein the modulated complementary Golay sequence can be continuously transmitted while the transducer receives the reflected signal.
